(19) United States
(12) Patent Application Publication
(10) Pub. No.: US 2025/0333817 A1
(43) Pub. Date: Oct. 30, 2025

(54) Method of Manufacturing a Mixture of Pure Copper and Carbon Nanotubes and of Additive Manufacturing of a Nanocomposite Material Having a Metallic Matrix of Pure Copper Reinforced With Carbon Nanotubes by Means of Such Mixture

(71) Applicants: ISTITUTO NAZIONALE DI FISICA NUCLEARE, Frascati (Roma) (IT); UNIVERSITA' DEGLI STUDI DI ROMA "LA SAPIENZA”, Roma (IT)

(72) Inventors: Valerio Pettinacci, Frascati (IT); Daniele Cortis, Frascati (IT); Francesco Pandolfi, Frascati (IT); Ilaria Carmela Rago, Roma (IT); Gianluca Cavoto, Roma (IT)

(21) Appl. No.: 18/867,155

(22) PCT Filed: May 17, 2023
(86) PCT No.: PCT/IB2023/055084

§ 371 Date: Nov. 19, 2024

(30) Foreign Application Priority Data
May 20, 2022 (IT) 102022000010511

(51) Int. Cl. C22C 1/10; B22F 10/28; B22F 10/36; B33Y 10/00; B33Y 70/10; C22C 1/04

(52) U.S. Cl. CPC C22C 1/1084; B22F 10/28; B22F 10/36; C22C 1/0425; B33Y 10/00; B33Y 70/10

(57) ABSTRACT

A method of producing a mixture of copper powders and carbon nanotubes includes the steps of: functionalizing carbon nanotubes with a functional group such to increase the repulsive electrostatic forces among the carbon nanotubes, dispersing the functionalized carbon nanotubes in a solvent, the dispersion being carried out by sonication, adding pure copper powder to the suspension obtained by the dispersion of the functionalized carbon nanotubes in the solvent in an amount such that the carbon nanotubes constitute between 0.05% and 0.5% by weight of the mixture of copper powders and carbon nanotubes, the copper powder including particles with a diameter comprised between 5 μm and 40 μm measured in accordance with ASTM B822 standard, and mixing the suspension during the addition of the copper powder and until the solvent evaporates.

### TECHNICAL FIELD

The present invention refers to the sector of materials science. In particular, the present invention concerns a method of producing a mixture of pure copper and carbon nanotubes and a related method of manufacture of a metal matrix nanocomposite material of pure copper reinforced with carbon nanotubes using said mixture and the nanocomposite material produced through this manufacturing method.

### STATE OF THE ART

Recently, several studies (the prior art documents [1]-[9] are reported below) have highlighted the possibility of developing copper (Cu) nanocomposite materials and carbon nanotubes (CNTs) in order to improve the performance and the versatility of copper so as to expand the application possibilities of this material.

Substantially two approaches to the production of the Cu/CNTs nanocomposite materials are known in the art.

The first approach consists of a powder metallurgy process comprising a step of mixing the Cu/CNTs powders (by means of ball milling, ultra-sonication, mixing at the molecular level), a compaction step (by means of SPS, Spark Plasma Sintering), a microwave sintering step, a hot isostatic pressing (HIP) step and a high pressure torsion (HPT) step.

The second approach consists in the electrochemical deposition, wherein copper is deposited electrochemically on moulds made up of carbon nanotubes. In detail, the carbon nanotubes act as a cathode to which the copper ions (Cu₂⁺) are fixed in solution (see prior art documents [4] and [10]).

In addition to the two main approaches described above, other methods for the realization of the metal matrix nanocomposites have recently been proposed, such as physical vapor deposition (PVD) or liquid phase processing, for example, stirring or stir casting, compression or squeeze casting, infiltration and spray deposition processes (see prior art documents [11] and [12]).

However, the methods described above are complex in the execution and require a plurality of sophisticated machines to be carried out. In addition, the Cu/CNTs nanocomposite materials obtained by the known methods have limitations that do not allow to obtain an ideal structure and therefore are found to have performance well below the ideally achievable performance.

For example, with reference to the powder metallurgy process, the optimal combination between metal and reinforcement is not easily obtainable due to the existence of a weak bond at the interface between the metal matrix and the carbonaceous reinforcement, non-uniform distribution of the secondary phase, residual stresses, dislocations and formation/propagation of cracks at the interface, differential thermal expansions and contractions between the two materials, possible formation of aggregates.

Finally, all the approaches presented above produce a semi-finished made of Cu/CNTs nanocomposite material that must be subjected to a further processing, in order to obtain the desired final product—for example, a heat exchanger or a portion thereof.

These disadvantages of the known solutions prevent the widespread adoption thereof in the manufacturing sector.

Furthermore, although additive manufacturing (AM) methods are known—in particular the Laser Powder Bed Fusion (LPBF) technology-which allow the manufacturing of finished products starting from metal powders (i.e., Ti, Al, W, steel matrix composites) (see prior art documents [10], [13] and [14]), none of these methods has been successfully used in the production of pure copper products and/or Cu/CNTs nanocomposite materials.

In fact, the high reflectivity of copper at the wavelengths of the traditional laser sources (in particular, with wavelength in the infrared range) used in the LPBF-type AM processes, as well as the remarkable thermal conductivity of copper, lead to the realization of low-density copper parts (<98%). In other words, the copper products made through AM are characterized by substantially lower performance than corresponding products obtained by means of traditional subtractive production methods.

### CITED PRIOR ART DOCUMENTS

[1] Z. Huang, Z. Zheng, S. Zhao, S. Dong, P. Luo, L. Chen: “Copper matrix composites reinforced by aligned carbon nanotubes: Mechanical and tribological properties”, Materials and Design, 133, 570-578, 2017.
[2] D. Janas, B. Liszkab: “Copper matrix nanocomposites based on carbon nanotubes or graphene”, Materials Chemistry Frontiers, 2, 22-35, 2018.
[3] Z. Zheng, Y. Chen, M. Zhang, J. Liu, A. Yang, L. Chen, Q. Yang, D. Lou, D. Liu, “Fabrication of carbon nanotubes/Cu composites with orthotropic mechanical and tribological properties”, Materials Science & Engineering A, 804, 140788, 2021.
[4] R. M. Sundaram, A. Sekiguchi, M. Sekiya, T. Yamada, Kenji Hata: “Copper/carbon nanotube composites: research trends and outlook”, R. Soc. open sci., 5, 180814, 2018.
[5] R. Shoukat, M. Imran Khan: “Carbon nanotubes: a review on properties, synthesis methods and applications in micro and nanotechnology”, Microsystem Technologies, 2021.
[6] O. Hjortstam, P. Isberg, S. Saderholm, H. Dai: “Can we achieve ultra-low resistivity in carbon nanotube- based metal composites”, Appl. Phys. A 78, 1175-1179, 2004.
[7] K. Chu, Q. Wu, C. Jia, X. Liang, J. Nie, W. Tian, G. Gai, H. Guo: “Fabrication and effective thermal conductivity of multi-walled carbon nanotubes reinforced Cu matrix composites for heat sink applications”, Compos. Sci. Technol. 70, 298-304, 2010.
[8] X. Long, Y. Bai, M. Algarni, Y. Choi, Q. Chen: “Study on the strengthening mechanisms of Cu/CNT nano-composites”, Mater. Sci. Eng. A 645, 347-356, 2015.
[9] M. Ghorbani-Asl, P. D. Bristowe, K. Koziol: “A computational study of the quantum transport properties of a Cu-CNT composite”, Phys. Chem. Chem. Phys. 17, 18 273-18 277, 2015.
[10] A. Mostafaei, A. Heidarzadeh, D. Brabazon: “Production of Metal Matrix Composites Via Additive Manufacturing”, Encyclopedia of Materials: Composites, 2, 605-614, 2021.
[11] B. Han, E. Guo, X. Xue, Z. Zhao, L. Luo, H. Qu, T. Niu, Y. Xu, H. Hou: “Fabrication and densification of high performance carbon nanotube/copper composite fibers”, Carbon 123, 593-604, 2017.
[12] H. Ye, X. Y. Liu, H. Hong: “Fabrication of metal matrix composites by metal injection molding-A review”, J. Mater. Process. Technol., 200, 12-24, 2008.
[13] S. Dadbakhsh, R. Mertens, L. Hao, J. Van Humbeeck, J. Kruth: “Selective Laser Melting to Manufacture “In Situ” Metal Matrix Composites: A Review, Adv. Eng. Mater., 21, 1801244, 2019.
[14] M. Prasad Behera, T. Dougherty, S. Singamneni: “Conventional and Additive Manufacturing with Metal Matrix Composites: A Perspective”, Procedia Manufacturing, 30, 159-166, 2019.

### OBJECTS AND SUMMARY OF THE INVENTION

An object of the present invention is to overcome the drawbacks of the prior art.

In particular, an object of the present invention is to provide a method of preparing a mixture of pure copper powder and carbon nanotubes with a uniform dispersion of the carbon nanotubes in the copper powder.

A particular object is to provide a process for the preparation of a mixture of pure copper powder and carbon nanotubes optimized for use in an additive manufacturing process.

A further object of the present invention is to present a method of producing high-performance artefacts in Cu/CNTs nanocomposite material through an additive manufacturing procedure.

Herein, the expression “high performance” refers to mechanical strength values (elastic modulus and ultimate tensile strength) that are higher than the mechanical resistance values of the same pure copper artefact (preferably Cu≈99.7±0.1 wt %, but also higher values) and realized by additive manufacturing, in particular, by LPBF technology based on conventional lasers—in general, laser sources in the infrared field, for example with wavelength approximately equal to 1064 nm and nominal power approximately equal to 200 W.

These and other objects of the present invention are achieved by a system incorporating the features of the accompanying claims, which form an integral part of the present description.

According to a first aspect, the present invention is directed to a method of producing a mixture of copper powders and carbon nanotubes. The method comprises functionalizing carbon nanotubes, or CNTs, with a functional group such to increase the repulsive electrostatic forces between the carbon nanotubes and dispersing the functionalized carbon nanotubes in a solvent. In particular, the dispersion of the CNTs in the solvent is carried out by means of sonication. In addition, the method comprises adding copper powder to the suspension, obtained by the dispersion of the functionalized carbon nanotubes in the solvent, and mixing the suspension during the addition of the copper powder and until the solvent evaporates. In particular, the copper powder comprises particles with diameter comprised between 5 μm and 40 μm. In one embodiment the copper powder consists of particles with diameter comprised between 5 μm and 40 μm. Preferably, the measurements of the copper powder particles are determined in accordance with ASTM B822 standard, i.e. using a test system and test conditions adhering to ASTM B822 standard. In addition, the copper powder is added in an amount such that the carbon nanotubes constitute between 0.05% and 0.5% by weight of the mixture of copper powders and carbon nanotubes.

Thanks to this method it is possible to obtain in a simple and economical way a mixture of copper powders and carbon nanotubes with a homogeneous dispersion of the CNTs in the copper powder, free of agglomerates or aggregates of substantially larger dimensions than the copper particles, which allows to obtain products characterized by a particularly low porosity.

In one embodiment, the step of dispersing the CNTs in the solvent by sonication comprises actuating a sonotrode to operate in a pulsed regime, preferably with a period of 1 s and activation time equal to half a period.

Preferably, the amplitude of the ultrasounds generated by the sonotrode is comprised between 22.8 μm and 96.9 μm, preferably equal to 79.8 μm.

In one embodiment, the step of dispersing the CNTs in the solvent comprises carrying out the dispersion for a period of time comprised between 10 and 30 minutes, preferably equal to 15 minutes.

In one embodiment, the suspension comprising solvent and CNTs is maintained at a temperature comprised between 5° C. and 20° C., preferably equal to 15° C.

The Applicant has found that carrying out the sonication with the above characteristics allows to obtain an optimal dispersion of the CNTs in the solvent. In particular, maintaining the suspension of CNTs and solvent thermostated allows to prevent the solvent from evaporating during sonication, avoiding an unwanted variation of the concentration of the CNTs in the suspension that would compromise the quality of the mixture of copper powders and final CNTs.

In one embodiment, the nanotubes are CNTs having an external diameter comprised between 10 nm and 30 nm, a length comprised between 10 μm and 30 μm, and preferably, they are of the multiple wall type. In general, the external diameters of the CNTs are determined by analysing data acquired by an HR-TEM (High Resolution Transmission Electron Microscopy) system, while the lengths of the CNTs are determined by analysing data acquired by a TEM (Transmission Electron Microscopy) system. In particular, samples of CNTs are first dispersed in ethanol and, then, a drop of suspension is taken and deposited on a (lacey carbon copper grid and images are acquired by the HR-TEM/TEM system. The diameter and the length of the CNTs are determined by the analysis of the acquired images. In particular, the edges of the CNTs are identified by detecting light/dark contrast oscillations in the acquired images. The diameter is measured as the distance between the average values of the light/dark contrast oscillations at opposite edges of the walls of the CNTs substantially parallel to a main development direction of the CNTs. Otherwise, the length of the CNTs is measured as the average distance between the end edges of each CNT opposed one another along the main length direction of the CNT. An example of such a CNTs size measurement procedure is described in Rago, I., Rauti, R., Bevilacqua, M., Calaresu, I., Pozzato, A., Cibinel, M., Dalmiglio, M., Tavagnacco, C., Goldoni, A., Scaini, D.: “Carbon Nanotubes, Directly Grown on Supporting Surfaces, Improve Neuronal Activity in Hippocampal Neuronal Networks”, Adv. Biosys, 2019, 3, 1800286.

In this case, carboxyl groups are used to carry out the functionalization of the CNTs.

In one embodiment of the present invention, the copper powder is added in an amount such that the carbon nanotubes constitute between 0.05% and 0.4%, more preferably constitute between 0.1% and 0.3%, by weight of the mixture of copper powders and carbon nanotubes.

In one embodiment, the copper powder has a purity equal to 99.7±0.25 wt %. Preferably, the percentage of carbon nanotubes equal to 0.25% (0.25 wt %) by weight of said mixture.

In one embodiment, the copper powder has a purity equal to 99.95±0.1 wt %. In this case, wherein the mixture of copper powders and carbon nanotubes comprises a percentage of carbon nanotubes not higher and preferably equal to 0.125% (0.125 wt %) by weight of said mixture.

The Applicant has determined that this ratio between copper powder and CNTs allows to obtain artefacts characterized by particularly high thermal and mechanical performance through the use of the Laser Powder Bed Fusion (LPBF) metal additive technology—in particular, the Selective Laser Melting (SLM) technology, i.e. selective fusion of a metal powder bed by means of a laser source.

Preferably, the addition of copper powder to the suspension of solvent and carbon nanotubes is carried out at a rate comprised between 5 g/s and 20 g/s.

The Applicant has verified that adding the copper powder to the suspension at such speed allows to obtain a rapid mixing of the copper powder to the CNTs avoiding, at the same time, the formation of agglomerates.

In one embodiment, the mixing of the suspension of solvent and CNTs added with copper powder takes place by stirring said suspension by means of a stirrer configured to rotate with a rotation speed comprised between 200 rpm and 1500 rpm, preferably equal to about 600 rpm.

Preferably, the stirrer is a magnetic stirrer configured to rotate the magnetic pawl at the speed indicated above.

The mixing of the suspension as defined above allows to obtain an optimal mixing of the copper powder with the CNTs.

In one embodiment, the solvent is isopropyl alcohol. In this case, the step of mixing said suspension of solvent and CNTs added with copper powder comprises maintaining the temperature of the suspension comprised between 85° C. and 95° C., preferably equal to 90° C.

Maintaining the temperature of the suspension of solvent and CNTs added with copper powder within this range of values allows a progressive evaporation of the solvent to be obtained, further limiting the likelihood of excessively sized agglomerations being formed.

According to a different aspect, the present invention concerns a method of additive production of an artefact in nanocomposite material comprising copper. This method comprises arranging a layer of a mixture of copper powders and CNTs obtained through the method according to any one of the preceding embodiments. The layer of mixture of copper powder and CNTs is radiated with a laser beam, according to a pattern defined by the artefact to be produced. The previous steps are repeated until the complete realization of the artefact. Advantageously, the step of radiating the layer of mixture of copper powders and CNTs comprises controlling the radiation of the layer of the mixture in order to transmit a predetermined energy density to said mixture.

Thanks to the use of the mixture of copper powders and CNTs described above, a greater flowability/fluidity of the melting micro-bath is obtained, created by radiation by means of laser beam. The homogeneity of the mixture of copper powders and CNTs, substantially free of agglomerates, prevents the formation of defects in the obtained parts due, for example, to the lack of melting of portions of the mixture of copper powders and CNTs.

The above reported method allows to realize with great speed and simplicity ready-to-use parts extremely resistant from the structural point of view and very efficient from the point of view of the thermal conduction, in particular such as to exhibit a yield strength that is higher than the common copper alloys by several tens of MPa, without the need to apply appropriate thermal or chemical treatments, at the same time improving, or at least maintaining unaltered the thermal properties. This makes it possible to realize components in which it is required to combine both structural and thermal dissipation performance, without having to use other materials such as titanium and aluminium.

Preferably, the radiation of the layer of mixture of copper powders and carbon nanotubes is controlled by adjusting one or more of the following operating parameters:
scanning speed—that is the displacement speed of the laser beam on the surface of incidence;
power emitted by the laser beam;
minimum distance between two adjacent “traces” left by the laser beam on the surface of incidence, and
thickness of the layer of the mixture of Cu/CNTs powders deposited at each iteration, in order to transmit the predetermined energy density to said mixture.

Acting on one or more of the above indicated parameters allows to easily control the energy density transmitted to the layer of mixture of copper powders and CNTs with extreme precision.

In one embodiment, the predetermined energy density is comprised between 250 J/mm³ and 480 J/mm³, preferably comprised between 290 J/mm³ and 440 J/mm³.

In one embodiment, the mixture of copper powders and carbon nanotubes comprises a percentage of carbon nanotubes comprised between 0.1% (0.1 wt %) and 0.3% (0.3 wt %), preferably equal to 0.25% (0.25 wt %), by weight of said mixture of powders. In this case, the energy density transmitted to said powder mixture is equal to 364 J/mm³.

These values of transmitted energy density allow to obtain even complex structures characterized by high thermal performance—typical of copper and of the alloys thereof—and mechanical performance and avoid structural defects such as unwanted cavity formations within the structure.

Further features and objects of the present invention will be more evident from the description of the accompanying drawings.

### BRIEF DESCRIPTION OF THE DRAWINGS

The invention will be described below with reference to some examples, provided for explanatory and non-limiting purposes, and illustrated in the annexed drawings. These drawings illustrate different aspects and embodiments of the present invention and reference numerals illustrating structures, components, materials and/or similar elements in different drawings are indicated by similar reference numerals, where appropriate.

FIG. 1 is a flowchart of a method of preparing a mixture of copper powders and carbon nanotubes according to an embodiment of the present invention;

FIG. 2 is an image acquired with a digital optical microscope of the mixture of copper powders and carbon nanotubes according to an embodiment of the present invention;

FIG. 3 is a flowchart of a method of additive manufacture of a product realized starting from the mixture of copper powders and carbon nanotubes according to an embodiment of the present invention;

FIG. 4 is a histogram of comparison of the porosity of copper test samples and test samples in the mixture of copper powders and carbon nanotubes according to an embodiment of the present invention;

FIGS. 5A-5D are SEM micrographs of the cross-sections of test samples in pure copper and in the mixture of copper powders and carbon nanotubes according to an embodiment of the present invention, and

FIG. 6 is a graph showing stress-strain curves of test samples in pure copper and in the mixture of copper powders and carbon nanotubes according to an embodiment of the present invention.

### DETAILED DESCRIPTION OF THE INVENTION

While the invention is susceptible to various modifications and alternative constructions, some preferred embodiments are shown in the drawings and are described hereinbelow in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The use of “for example”, “etc.”, “or” indicates non-exclusive alternatives without limitation, unless otherwise indicated. The use of “includes” means “includes, but not limited to” unless otherwise indicated.

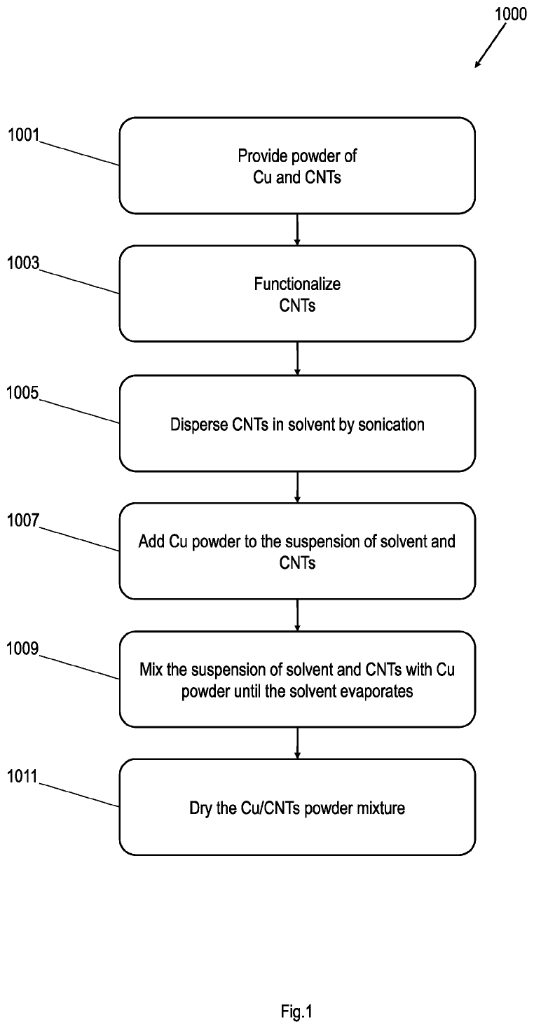

With reference to the flowchart of FIG. 1 a method 1000 of producing a mixture of pure copper, in brief also indicated with the corresponding chemical symbol Cu in the following, and carbon nanotubes, hereinafter indicated with the acronym CNTs, according to an embodiment of the present invention.

The method 1000 comprises using pure copper powder (Cu≈99.7±0.25 wt %, more preferably Cu≈99.7±0.1 wt %) with a fine particle size, preferably with a diameter comprised between 5 μm and 40 μm (5 μm≤d_{Cu}≤40 μm). Preferably, the impurities included in the copper powder comprise phosphorus P.

The carbon nanotubes have external diameter comprised between 10 nm and 30 nm (10 nm≤d_{CNT}≤30 nm), and length comprised between 10 and 30 μm (10 μm≤L_{CNT}≤30 μm) (step 1001). Preferably, the CNTs are of the multi-walled type or MWCNTs-acronym for Multi-Walled Carbon NanoTubes, even more preferably the MWCNTs have a purity greater than 95% by weight (MWCNTs≥95 wt %).

In particular, the sizes of the particles forming the copper powder are measured by means of a test apparatus and under conditions in accordance with ASTM B822 standard: “Standard Test Method for Particle Size Distribution of Metal Powders and Related Compounds by Light Scattering”.

The CNTs are subjected to a process of functionalization (step 1003). Preferably, the functionalization of the CNTs is carried out with carboxyl groups —COOH, which allow to increase the repulsive electrostatic forces among the CNTs. In particular, the functionalization aims to counteract the van der Waals forces that are established among CNTs, avoiding the consequent formation of aggregates.

The functionalized CNTs are then dispersed in a solvent, preferably isopropyl alcohol or IPA by means of a sonication procedure (step 1005). Preferably, although not in a limiting way, the concentration of CNTs dispersed in the solvent is comprised between 0.1%- and 0.3% of the total mass of the solution. In a preferred embodiment of the present invention, the dispersion of the CNTs in the isopropyl alcohol is carried out by means of a sonotrode. Preferably, the amplitude of the ultrasounds is maintained within a desired range of values. For example, in the case of using a Sonics Materials VC-750-220 model sonotrode from Fisher the amplitude of the ultrasounds is maintained between 20% and 85%, preferably between 65% and 75% of the nominal amplitude value of the ultrasounds generated by the sonotrode, equal to about 114 μm in the example considered, more preferably an amplitude equal to 70% of the nominal amplitude. In the example considered, the sonication is carried out for an overall execution time comprised between 10 and 30 minutes, preferably equal to about 15 minutes.

In a non-limiting manner, the sonotrode is configured to operate in a pulsed regime. Preferably, the pulsed regime has a period of about two seconds, during which the sonotrode generates ultrasounds for about one second and for about one second does not generate ultrasounds—i.e. the sonotrode has a duty cycle of 50%.

The Applicant has also found that during sonication there is an increase in the temperature of the CNTs/IPA suspension, an effect that causes a reduction in the power transferred from the sonotrode to the CNTs/IPA suspension and an undesired evaporation of the solvent. For this reason, during sonication the CNTs/IPA suspension is preferably maintained at a value or within a range of sonication temperature values such that the solvent (IPA) does not evaporate and, at the same time, no significant reductions in the transfer of power occur. In the case considered, these effects are obtained by maintaining the sonication temperature comprised between 10° C. and 20° C. Preferably, the CNTs/IPA suspension is thermostatted at a temperature equal to about 15° C. during sonication.

At the end of the sonication the CNTs/IPA suspension is characterized by a high homogeneity and stability.

At this point, the method 1000 comprises pure copper powder to be added to the CNTs/IPA suspension (step 1007).

In the preferred embodiment, the pure copper powder is progressively added while the CNTs/IPA suspension is maintained under stirring. Preferably, the stirring is carried out by means of a magnetic stirrer configured to rotate with a rotation speed comprised between 200 and 1500 rpm, preferably equal to 600 rpm.

In addition, the pure copper powder is added to the CNTs/IPA suspension with a speed comprised between 5 and 20 g/s until a desired weight ratio between the copper powder and the CNTs is achieved. For example, the weight ratio Cu: CNTs is such that CNTs constitute between 0.05% and 0.5%, preferably between 0.05% and 0.4%, and more preferably between 0.1% and 0.3%, of the total weight of copper powder and CNTs.

The CNTs/IPA suspension added with the copper powder is mixed until complete evaporation of the isopropyl alcohol (step 1009). In detail, the evaporation time can be determined as a function of the contingent characteristics of the system used for the preparation of the mixture of Cu/CNTs powders. These characteristics comprise, in a not limiting manner, the temperature, the evaporation surface area and the volume of the solvent. Advantageously, the temperature of the CNTs/IPA suspension is maintained within a range of mixing temperature values, for example comprised between 85° C. and 95° C. Preferably, the CNTs/IPA suspension is thermostated at a temperature of about 90° C. during addition of pure copper and the stirring until evaporation of the IPA.

Finally, the mixture of Cu/CNTs powders obtained at the end of the evaporation of the IPA is oven-dried at a predetermined drying temperature to eliminate or at least reduce the humidity of the mixture of Cu/CNTs powders (step 1011). For example, the drying temperature is comprised between 100° C. and 120° C., equal to about 110° C. for a drying time of 12 hours, using a copper powder with purity ≈99.7±0.1 wt %. Otherwise, if powders with a higher degree of purity are used—for example, oxygen-free copper, 99.99%—the temperature, the time and the drying conditions can be optimized empirically—as is the practice in AM operating procedures—in order to optimize the drying step to the specific case due to the great variability of the behaviour of the powders.

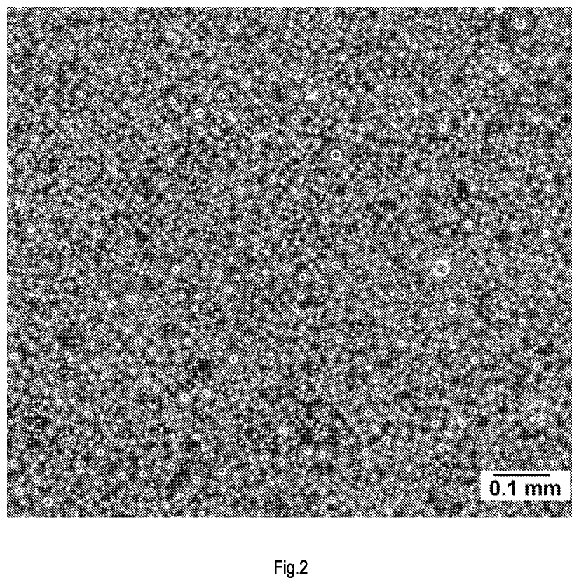

At the end of the method 1000, a mixture of Cu/CNTs powders is obtained in which the CNTs are homogeneously dispersed—as visible in FIG. 2 acquired by means of digital optical microscope.

The mixture of Cu/CNTs powders thus obtained is particularly suitable for use in additive manufacturing processes.

In one embodiment of the present invention, the mixture of Cu/CNTs powders is used for the manufacture of products and/or parts of products with high mechanical, thermal/electrical performance suitable for applications in the aerospace, automotive, naval, electronic, microelectronic, radiofrequency telecommunication field.

The Cu/CNTs composite materials obtained by means of the embodiments of the present invention can, for example, be used in the aerospace field for the creation of compact heat exchangers—sizes and mass are critical parameters for objects intended for flying—that allow a more efficient thermal management of satellites. In fact, the mixture of Cu/CNTs powders obtained by means of the embodiments of the present invention allows the realization of heat exchangers by means of additive manufacturing which are intended for installation spaces with complex geometry or that must combine heat dissipation functions with an appropriate structural strength of the apparatus as a whole.

In the context of the telecommunications, the Cu/CNTs nanocomposite materials obtained by means of the embodiments of the present invention can be used for the realization, by means of additive manufacturing and subsequent surface finishing, of microwave antennas, for example operating at frequencies around 90 GHz (millimetric waves), which are currently made with conventional techniques, using gold-plated copper, with an expensive process and difficult to replicate uniformly.

In the naval and automotive field, the Cu/CNTs nanocomposite materials obtained by means of the embodiments of the present invention can be used for the realization, by means of additive manufacturing, of heat exchangers much more compact than current commercial solutions, as well as provided with the mechanical properties necessary for the operation and for maintaining the efficiency of the main hybrid and electric propulsion systems. The aspect of the size reduction is strategic in the electric motors given the large footprint and weight of the batteries and of the ancillary systems. The heat exchangers realized by means of additive manufacturing in Cu/CNTs nanocomposite material according to the embodiments of the present invention are characterized by an excellent thermal conductivity (typical of the copper alloys), high mechanical properties that can be easily optimized for the needs of the specific application by adjusting the used percentage of CNTs and ability to obtain compact objects as well as by the complex geometry thanks to the processability obtained by means of additive manufacturing.

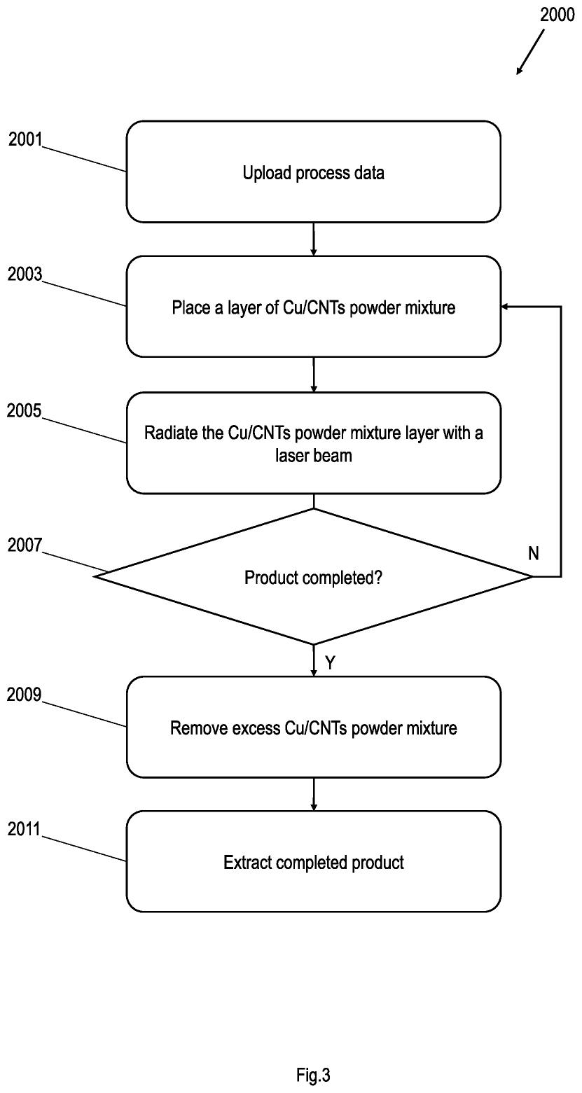

In particular, a method 2000 of additive manufacturing optimized for use with the mixture of Cu/CNTs powders is described below, with reference to the flowchart of FIG. 3.

The method 2000 of additive manufacturing is of the Selective Laser Melting type or SLM, acronym thereof, and belongs to the category of Laser Powder Bed Fusion or LPBF—acronym thereof. For example, the method 2000 can be implemented by means of an SLM machine of MySint100 model produced by SISMA S.p.A.

The method 2000 comprises loading, into a control unit of the SLM machine, process data containing the information necessary for the creation of a desired piece (step 2001). Generally, the process data are contained in a stereolithography file, for example a STL (STereo Lithography) format file.

Subsequently, a layer of the mixture of Cu/CNTs powders—obtained by means of the method 1000—is placed in a processing chamber of the SLM machine (step 2003). This operation is generally carried out automatically by the SLM machine. For example, the layer of the mixture of Cu/CNTs powders deposited by the SLM machine has a thickness comprised between 15 μm and 25 μm, preferably equal to 20 μm, and an extension congruent with the dimensions of the piece to be produced. Preferably, a controlled atmosphere is maintained within the processing chamber by means of inert gases such as argon Ar or nitrogen N₂.

The layer of the mixture of Cu/CNTs powders is radiated by a laser beam (step 2005). In particular, the laser beam impinges on a portion of the layer of the mixture of Cu/CNTs powders and according to a path defined by the processing unit of the SLM machine on the basis of the previously loaded process data. For example, the laser beam uses photons in the infrared, with a wavelength λ=1064 nm.

Subsequently, a new layer of mixture of Cu/CNTs powders is arranged which is then radiated by the laser, i.e. steps 2003 and 2005 are repeated (decision step 2007) until the piece to be produced is completed (output branch Y of decision step 2007), after which the excess mixture of Cu/CNTs powders is removed (optional step 2009) and the produced piece is extracted from the 3D printer (step 2011). In other words, at each iteration of steps 2003-2005 the laser beam generates a melting micro-bath in desired portions of the deposited layer of the mixture of Cu/CNTs powders. Such molten portions of the layer of the mixture of Cu/CNTs powders cool and solidify substantially instantaneously with respect to the processing times. Therefore, the processing of each layer superimposed on the previous one leads to, layer after layer, obtaining the piece defined by the process data.

The Applicant has determined that the control of the energy density transmitted to the mixture of Cu/CNTs powders by means of the laser allows to realize products with geometric shapes and/or complex functional components (such as internal cooling channels) in a single piece and provided with structural characteristics and thermal and/or electrical conductivity suitable for use in application fields characterized by particularly stringent constraints, such as the aerospace sector.

In detail, in the embodiments of the present invention, during the execution of step 2005 the method 2000 provides a sub-procedure 2100 for controlling the energy density transmitted to the mixture of Cu/CNTs powders.

The sub-procedure 2100 ensures that the energy density E transmitted to the mixture of Cu/CNTs powders by the laser beam is within a range of optimal values. For this purpose, the sub-procedure 2100 comprises adjusting one or more of the following operating parameters:
scanning speed v—that is the displacement speed of the laser beam on the surface of incidence;
power P emitted by the laser beam;
minimum distance H between two adjacent “traces” left by the laser beam on the surface of incidence, and
thickness s of the layer of the mixture of Cu/CNTs powders deposited at each iteration.

In particular, in the embodiments of the present invention, the energy density E transmitted to the mixture of Cu/CNTs powders by the laser beam is calculated by the following formula:

$$E = P / vHs . \qquad ( 1 )$$

Preferably, in the embodiments of the present invention the sub-procedure 2100 is configured to ensure that the energy density E transmitted to the mixture of Cu/CNTs powders is, more preferably, comprised between 290 J/mm³ and 440 J/mm³. In the case of a mixture of Cu/CNTs powders with a percentage of CNTs equal to 0.1% (0.1 wt %) by weight, the Applicant has determined that the optimal value of the energy density E is equal to 364 J/mm³.

In other words, thanks to the implementation of the sub-procedure 2100 it is possible to manufacture artefacts in nanocomposite materials in copper and carbon nanotubes by means of a metal additive machine designed for the realization of artefacts in metals or metal alloys free of nanomaterials.

### Comparative Tests

In order to evaluate the advantages of the artefacts produced with the mixture of Cu/CNTs powders according to the methods 1000 and 2000 described above, test samples were produced in pure copper powder, and in mixture of Cu/CNTs powders.

In particular, two types of test samples have been created:
−5 mm sided cubes, for density analysis,
10×10 mm sided plates 2 mm in thickness for SEM characterization, and
tensile samples in accordance with ASTM E8 standard, for the evaluation of the mechanical properties.

### Samples in Mixture of Cu/CNTs Powders According to an Embodiment of the Invention

The samples in mixture of Cu/CNTs powders were produced starting from a mixture of Cu/CNTs powders obtained according to the method 1000, with a percentage of CNTs equal to 0.1% (0.1 wt %) by weight for the cubic samples and 0.25% by weight (0.25 wt %) for the tensile samples, and processed according to the method 2000, transmitting an energy density of 364.6 J/mm³ by adjusting the operating parameters as follows:
scanning speed v equal to 600 mm/s;
emitted power P equal to 175 W;
minimum distance H equal to 40 μm, and
thickness s of the layer of the mixture of Cu/CNTs powders equal to 20 μm.

In addition, argon with a recirculation speed equal to 4 m/s was used for conditioning the processing chamber of the SLM machine.

### Comparative Samples in Pure Copper

The test samples in pure copper were produced according to the method 2000 using the same parameters as indicated above for the production of the test samples in mixture of Cu/CNTs powders.

In addition, a part of the samples was then subjected to heat treatment carried out at 800° C. for 40 hours.

### Comparison of the Porosity

The quantitative porosity assessment was carried out on digital cross-sectional images of the cubic test samples according to ASTM E-2109-01 standard. Digital images were acquired with 200× magnifications, using a Nikon Eclipse L150 optical microscope combined with LUCIA Measurement image analysis software. For this analysis, the images were acquired in greyscale digitally through a greyscale threshold and the porosity was evaluated through the relationship between the dark and light areas, calculated by the software itself, in a similar way to what described in I. Rago, M. Iannone, F. Marra, M. P. Bracciale, L. Paglia, D. Orlandi, D. Cortis, V. Pettinacci: “3D-printed pure copper: density and thermal treatments effects”, Proceedings of the Second International Conference on Design Tools and Methods in Industrial Engineering, A D M 2021, pages 721-728, Sep. 9-10, 2021.

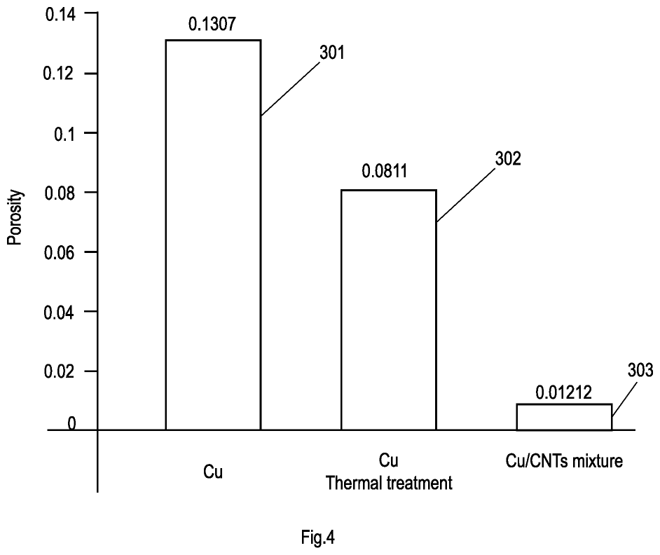

As can be appreciated in the histograms of FIG. 4, the porosity values of the samples in pure copper without heat treatment (bin 301) and samples in pure copper subjected to heat treatment (bin 302) are substantially greater than the porosity values of the samples in mixture of Cu/CNTs powders (bin 303). In particular, the porosity of the samples in mixture of Cu/CNTs powders is reduced by a factor of 10 compared to the porosity of the samples in pure copper.

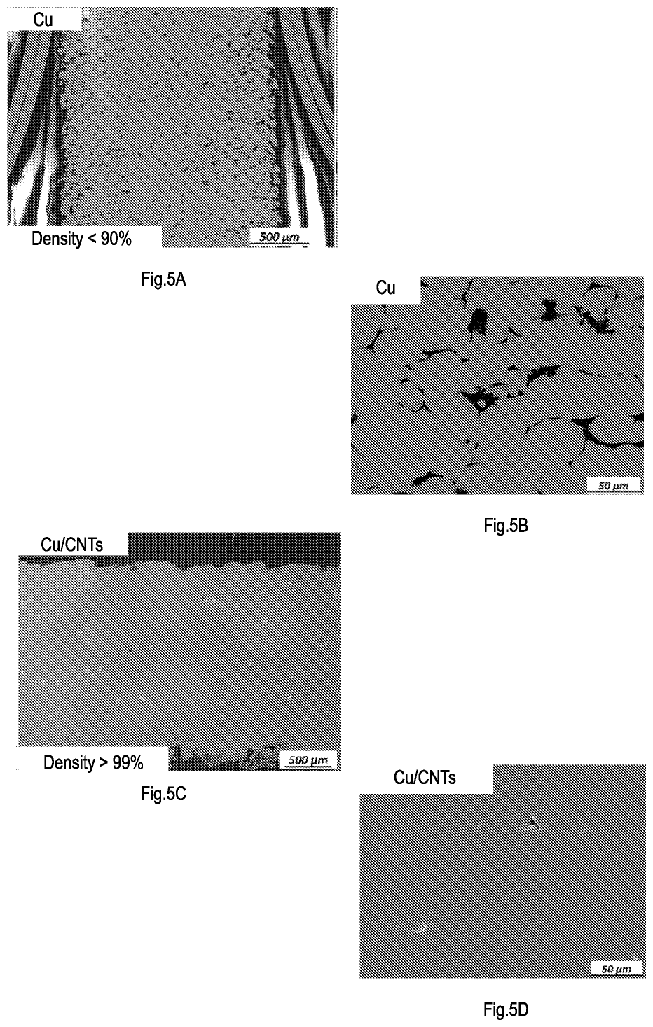

In other words, as can be appreciated from FIGS. 4A-4D which are SEM micrographs of the cross-sections of the 10×10 mm-sided plates 2 mm in thickness in pure copper (FIGS. 5A and 5B) and in mixture of Cu/CNTs powders (FIGS. 5C and 5D), the samples in mixture of Cu/CNTs powders have a density close to 99%, substantially better than the density of the samples in pure copper which has values of less than 90%.

### Comparison of the Mechanical Properties

The mechanical properties were evaluated through tensile tests on a test machine model 5584 produced by Instron equipped with a 150 kN load cell and at a displacement speed of the crosspiece of 1 mm/min according to the ASTM E8 standard.

The tensile tests highlighted a significant improvement of the mechanical properties of the tensile samples in mixture of Cu/CNTs powders compared to the samples in pure copper (Cu≈99.7±0.1 wt %) produced by means of the same LPBF parameters, but without the addition of the CNTs.

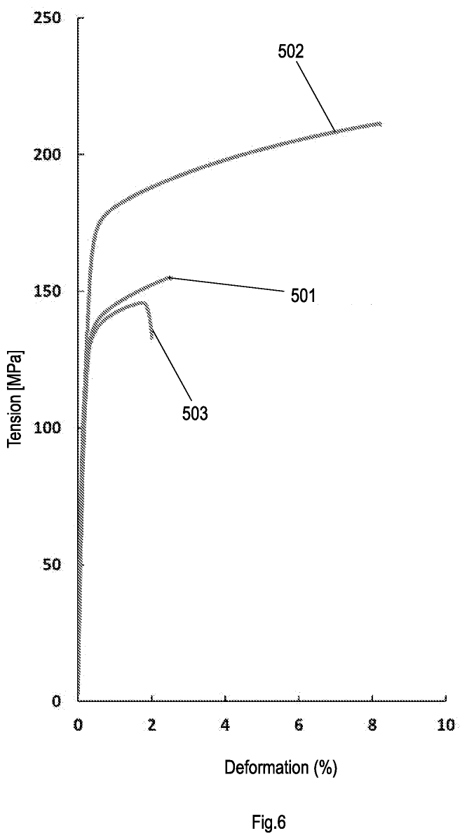

As can be appreciated from the stress-strain curves reported in the graph of FIG. 6, the tensile samples in mixture of Cu/CNTs powders (0.1 wt %), curve 501 have a tensile strength substantially higher than 150 MPa, while the tensile samples in mixture of Cu/CNTs powders (0.25 wt %), curve 502, have a tensile strength substantially higher than 200 MPa, more than doubled with respect to the tensile strength measured for the tensile samples in pure copper, curve 503, (substantially less than 100 MPa). The Applicant has found that the improvement of the mechanical properties in the samples has an exponential trend as a function of the percentage by weight of CNTs in the Cu/CNTs material.

However, it should be clear that the above reported examples must not be interpreted in a limiting sense and the invention thus conceived is susceptible of numerous modifications and variations.

In alternative embodiments use is made of copper powder with a different purity. In particular, the Applicant has determined that as the purity of the copper powder used increases, the amount of CNTs to be added to obtain optimal performance is reduced, on the contrary it is possible to determine an upper limit value of the amount of CNTs beyond which the mixture of copper powder and CNTs does not allow to produce artefacts or the obtained artefacts have sub-optimal mechanical strength characteristics. For example, in one embodiment, a copper powder with purity of 99.95 wt % is used. In this case, the Applicant has determined that the concentration of CNTs 0.125 wt % allows to obtain artefacts by additive manufacturing with optimal mechanical characteristics and, moreover, that beyond this value the quality of the artefacts deteriorates rapidly.

In particular, comparative tests carried out by the Applicant—analogous to the comparative tests described above—between samples in mixture of Cu/CNTs powders (Cu purity 99.95±0.1 wt % and CNT concentration equal to 0.125 wt %) and samples in pure copper (purity 99.95 wt %) have highlighted the following mechanical characteristics:

Tensile strength:
Pure copper: 39±2 MPa,
Mixture of Cu/CNTs powders: 106±4 MPa
   Elastic modulus:
Pure copper: 25.6±13.7 GPa,
Mixture of Cu/CNTs powders: 62.7±13.8 GPa.

In other words, the methods according to the present invention allow to obtain a mixture of copper powders and CNTs suitably combined and, therefore, to use said mixture to produce artefacts characterized by high mechanical performance.

As will be apparent to the person skilled in the art, one or more steps of the above-described method May be carried out in parallel with each other or in an order different from that presented above. Similarly, one or more optional steps can be added or removed from one or more of the procedures described above.

Naturally, all the details can be replaced with other technically-equivalent elements.

In conclusion, the materials used, as well as the shapes and contingent dimensions of the devices, apparatuses and terminals mentioned above, may be any according to the specific implementation needs without thereby departing from the scope of protection of the following claims.

1. A method of producing a mixture of copper powders and carbon nanotubes comprising the steps of:
functionalizing carbon nanotubes with a functional group such to increase the repulsive electrostatic forces among the carbon nanotubes;
dispersing the functionalized carbon nanotubes in a solvent, said dispersion being carried out by sonication;
adding copper powder to the suspension obtained by the dispersion of the functionalized carbon nanotubes in the solvent in an amount such that the carbon nanotubes constitute between 0.05% and 0.5% by weight of the mixture of copper powders and carbon nanotubes, said copper powder comprising particles with a diameter comprised between 5 μm and 40 μm measured in accordance with ASTM B822 standard; and
mixing said suspension during the addition of the copper powder and until the solvent evaporates.

2. The method according to claim 1, wherein the step of dispersing the carbon nanotubes in the solvent by sonication comprises actuating a sonotrode to operate in a pulsed regime.

3. The method according to claim 2, wherein the sonotrode operates in a pulsed regime with a period of 1 s and activation time equal to half a period.

4. The method according to claim 2, wherein the amplitude of the ultrasounds generated by the sonotrode is comprised between 22.8 μm and 96.9 μm.

5. The method according to claim 1, wherein the step of dispersing the carbon nanotubes in the solvent comprises carrying out the dispersion for a period of time comprised between 10 and 30 minutes.

6. The method according to claim 1, wherein the step of dispersing the carbon nanotubes in the solvent comprises maintaining the suspension comprising solvent and carbon nanotubes at a temperature comprised between 5° C. and 20° C.

7. The method according to claim 6, wherein the suspension is maintained at a temperature equal to 15° C.

8. The method according to claim 1, wherein the nanotubes are carbon nanotubes having an external diameter comprised between 10 nm and 30 nm, measured by analysing images acquired with a HR-TEM system, and a length comprised between 10 μm and 30 μm, measured by analysing images acquired by means of a HR-TEM or TEM system.

9. The method according to claim 8, wherein the carbon nanotubes are of the multi-walled type.

10. The method according to claim 1, wherein copper powder is added in an amount such that the carbon nanotubes are in an amount comprised between 0.1% and 0.3% by weight of the mixture of copper powders and carbon nanotubes.

11. The method according to claim 10, wherein the copper powder has a purity equal to 99.7±0.25 wt %.

12. The method according to claim 10, wherein the mixture of copper powders and carbon nanotubes comprises a percentage of carbon nanotubes equal to 0.25% (0.25 wt %) by weight of the mixture.

13. The method according to claim 10, wherein the copper powder has a purity equal to 99.95±0.1 wt % and wherein the mixture of copper powders and carbon nanotubes comprises a percentage of carbon nanotubes equal to 0.125% (0.125 wt %) by weight of the mixture.

14. The method according to claim 1, the step of adding copper powder to the suspension of solvent and carbon nanotubes comprises adding the copper powder at a rate comprised between 5 g/s and 20 g/s.

15. The method according to claim 1, wherein the step of mixing said suspension of solvent and carbon nanotubes added with copper powder comprises stirring the suspension of solvent and carbon nanotubes added with copper powder by means of a stirrer configured to rotate with a rotation speed comprised between 200 rpm and 1500 rpm.

16. The method according to claim 15, wherein the stirrer is a magnetic stirrer.

17. The method according to claim 1, wherein the solvent is isopropyl alcohol and wherein the step of mixing (1009) said suspension of solvent and carbon nanotubes added with copper powder comprises maintaining the temperature of the suspension comprised between 85° C. and 95° C.

18. The method according to claim 17, wherein the suspension is maintained at a temperature equal to 90° C.

19. A method of additive manufacturing of an artefact, comprising the steps of:
arranging a layer of mixture of copper powders and carbon nanotubes obtained according to the method of any one of the preceding claims;
radiating the layer of mixture of copper powder and carbon nanotubes with a laser beam, according to a pattern defined by the artefact to be produced;
repeating the previous steps until the complete realization of the artefact;
wherein the step of radiating the layer of mixture of copper powders and carbon nanotubes comprises controlling the radiation of the layer of mixture of copper powders and carbon nanotubes by adjusting one or more of the following operating parameters:
scanning speed—that is the displacement speed of the laser beam on the surface of incidence;
power emitted by the laser beam;
minimum distance between two adjacent traces left by the laser beam on the surface of incidence; and
thickness of the layer of the mixture of copper powders and carbon nanotubes deposited at each iteration, in order to transmit a predetermined energy density to said mixture.

20. The method according to claim 19, wherein the predetermined energy density is comprised between 250 J/mm³ and 480 J/mm³.

21. The method according to claim 20, wherein
the predetermined energy density is comprised between 290 J/mm³ and 440 J/mm³.

22. The method according to claim 20, wherein the mixture of copper powders and carbon nanotubes comprises a percentage of carbon nanotubes comprised between 0.1% (0.1 wt %) and 0.3% (0.3 wt %) by weight of said mixture, and wherein the transmitted energy density to said mixture is equal to 364 J/mm³.

23. The method according to claim 22, wherein the mixture of copper powders and carbon nanotubes comprises a percentage of carbon nanotubes equal to 0.25% (0.25 wt %) by weight of said mixture.
